(19) United States
(12) Patent Application Publication
(10) Pub. No.: US 2007/0048431 A1
(43) Pub. Date: Mar. 1, 2007

(54) Emulsions for confectionery applications

(76) Inventors: Christopher E. Budwig, Dublin, OH (US); Darryl Barwick, Marysville, OH (US); Guillermo Napolitano, Dublin, OH (US); Thomas Kmietsch, Marysville, OH (US)

Correspondence Address: BELL, BOYD & LLOYD LLC, P. O. BOX 1135, CHICAGO, IL, 60690-1135, US

(21) Appl. No.: 11/216,741

(22) Filed: Aug. 31, 2005

(51) Int. Cl. A23D 7/00

(52) U.S. Cl. 426/602

(57) ABSTRACT

Emulsions for confectionery coating applications and methods regarding same are provided. In an embodiment, the emulsions comprise a water phase, a fat phase having at least one emulsifier and at least one tempering fat, and a seeding agent. The shelf-table emulsions do not need to be refined or conched and can be effectively utilized for confectionery molding, enrobing or panning applications.

### BACKGROUND

The present invention relates generally to confectionery products. More specifically, the present invention relates to emulsions for confectionery applications and methods regarding same.

Traditional fat-based confections typically have a high fat and calorie content. In addition, in some instances they utilize partially hydrogenated and lauric fats in their compositions. The inclusion of such partially hydrogenated fats can have negative impacts on health because of the likelihood of high levels of trans-fats, which are known to adversely increase cholesterol levels in human. The use of lauric fats in a confectionery coating having a high water content increases the risk of hydrolytic rancidity leading to confections that become easily spoiled and not consumable.

Emulsions can be used in confectionery applications. These emulsions can be formed having lower fat and calorie content than that of traditional fat-based confections. Unfortunately, many of the currently known emulsion-type confectionery masses are soft and best suited for center or filling applications. As such, they do not have a sufficient structure to enable them to be used for certain confectionery applications. For example, these emulsion-type confectionery masses do not have the structural integrity or performance characteristics that allow them to be used in coating applications.

There have been a limited number of emulsion-type confectionery masses that have been previously described which reportedly do have sufficient structure and function to be used in coating applications. However, these previously described emulsion-type confectionery masses have distinct disadvantages including reliance on lauric fat, partially hydrogenated fats or waxes. Additionally the majority of these emulsions rely on the incorporation of solids non-fat (typically cocoa solids or carbohydrates) in the fat continuous phase to provide sufficient structure to the emulsion-type mass. The disadvantage of dispersed solids non-fat is that this requires the particle size of the solids to be reduced which may require contamination of refiners and other chocolate manufacturing equipment. Another problem with existing emulsion-style confectionery masses that can be used as coatings is that they are intended for chilled or frozen distribution to the consumer.

Therefore, there is a need to provide improved emulsions for use in confectionery applications that do not utilize undesirable ingredients (e.g. high level of trans- or lauric-fats), do not require utilization of chocolate manufacturing equipment (refiners and conches) and can be distributed at ambient temperatures.

### SUMMARY

The present invention relates to emulsions for confectionery applications and methods regarding same. In an embodiment, the present invention provides an emulsion comprising a water phase and a fat phase having at least one emulsifier and at least one tempering fat.

In an embodiment, the fat phase is low in partially hydrogenated fats and lauric fats and free of waxes.

In an embodiment, the fat blend is tempered to achieve the desired coating structure. For example, the fat blend can be composed primarily from tempering fat that is selected from the group consisting of cocoa butter, cocoa butter equivalents, cocoa butter improvers and combinations thereof.

In an embodiment, the cocoa butter equivalents are made from components selected from the group consisting of palm oil, sunflower oil, safflower oil, sheanut butter, illipe butter and combinations thereof.

In an embodiment, the emulsifier is selected from the group consisting of monoglycerides, diglycerides, polyglycerol polyricinoleate, succinylated monoglyceride, polysorbate 65, acetylated monoglycerides, citric acid ester of monoglycerides, lactic acid esters of monoglycerides, diacetyl-tartaric acid ester of mono/diglycerides, glycerol lactopalmitate, sodium stearoyl-2-lactylate, lecithin, polysorbate 80, sucrose hexaeucerate, sugar esters and combinations thereof.

In an embodiment, the sugar esters are selected from the group consisting of sucrose monostearate, sucrose monopalmitate, sucrose distearate, sucrose dipalmitate, sucrose alkylate and combinations thereof.

In an embodiment, the emulsion further comprises at least one seeding agent.

In an embodiment, the seeding agent is selected from the group consisting of bohenic-oleic-bohenic triglyceride, cocoa butter, cocoa butter equivalents, powdered cocoa butter and combinations thereof.

In an embodiment, the water phase comprises additives selected from the group consisting of fruit juices, fruit juice concentrates, vegetable juices, vegetable juice concentrates, preservatives, carbohydrates, gums, proteins, sugars, polyols, minerals, hydrocolloids, starches, flavoring agents, salts, acidulants, emulsifiers, high HLB emulsifiers, cocoa powders, coloring agents and combinations thereof.

In an embodiment, the water phase comprises additives selected from the group consisting of cocoa derived solids, dairy derived solids, nut derived solids, fruit derived solids, vegetable derived solids, soy derived solids and combinations thereof.

In an embodiment, the emulsion has a water activity ranging from about 0.3 to about 0.84.

In an embodiment, the emulsion is used as a coating for confectionery products.

In an embodiment, the emulsion is capable of forming a coating for a confectionery product by an application selected from the group consisting of molding, co-molding, enrobing, spray coating, pan coating and combinations thereof.

In an embodiment, the emulsion is shelf-stable.

In an embodiment, the present invention provides an emulsion for confectionery applications comprising: a water phase and a fat phase having at least one emulsifier, wherein the fat phase is low in partially hydrogenated fats and lauric fats and free of waxes.

In an embodiment, the present invention provides a method of making an emulsion, the method comprising: preparing a water phase by mixing and heating a combination of water and additives to form a syrup, preparing a fat phase by blending and heating at least one tempering fat and at least one emulsifier to form a fat blend, and combining the syrup with the fat blend to form the emulsion.

In an embodiment, the present invention provides a method of making an emulsion for confectionery coating applications, the method comprising: preparing a water phase by mixing and heating a combination of water and additives to form a syrup, preparing a fat phase by blending and heating at least one fat and at least one emulsifier to form a fat blend, wherein the fat phase is low in partially hydrogenated fats and lauric fats and free of waxes, combining the syrup with the fat blend, and adding at least one crystallized seeding agent to the combined syrup and fat blend to form the emulsion, wherein the emulsion does not need to be refined or conched.

An advantage of the present invention is to provide emulsions that have improved and modified flavor over traditional fat-based confectioneries.

Yet another advantage of the present invention is to provide emulsions that have higher levels of nutritional solids than tradition fat-based confectioneries.

Still another advantage of the present invention is to provide emulsions that can allow the use of water containing ingredients such as, for example, fruit juices or concentrates.

Another advantage of the present invention is to provide emulsions that have lower ingredient costs in delivering desirable solids (e.g. fruit solids) because the emulsions do not require the particular solids to be low in water content (e.g. no drying of fruit solids).

Yet another advantage of the present invention is to provide emulsions that deliver smooth mouthfeel without the expense of refining or conching. For example, the emulsions do not require conching to achieve a desired viscosity.

Still another advantage of the present invention is to provide emulsions that slow migration of water into dry components because aqueous droplets are embedded in the fat continuous phase.

Another advantage of the present invention is that the emulsion-type confectionery masses handle like typical fat-based suspensions (e.g. chocolate) such that they allow the syrups to be delivered to the final confection without the associated problems (e.g. sticking).

Additional features and advantages of the present invention are described in, and will be apparent from, the following Detailed Description.

### DETAILED DESCRIPTION

The present invention relates to novel emulsions for confectionery applications and methods regarding same. More specifically, the invention relates to emulsions that can be used, for example, as coatings and fillings for confectioneries and methods of producing the emulsions for confectionery products. Emulsions that are used as coating compositions will be referred to as emulsion coatings. The emulsions of the present invention are stable at ambient storage conditions. The present invention also relates to new water containing confectionery coatings that do not need to be refined or conched.

In an embodiment, the emulsions comprise a water-containing mass (e.g. >4%) that may be used for enrobing, mould depositing or pan coating. The emulsions are capable of release from a standard confectionery mold while maintaining structural integrity, which allows new product offerings. The emulsions may be used in a standard confectionery enrober for extended periods because the emulsion is more stable than previously known emulsion-type confections. The emulsions release from standard confectionery cooling and/or transfer belts. The emulsions can be co-deposited with conventional fat-based confectionery masses.

In an embodiment, the emulsions can form emulsion coatings that have the advantage over the prior art in that the emulsions have sufficient structure for coating and can be run on standard confectionery industrial equipment. For example, many of the previous emulsion-type confectionery masses described in the literature may only be used only for filling applications and not coating applications. Considerable effort has gone into creating emulsions of the present invention that have the performance characteristics necessary for coating applications.

Generally, confectionery coatings must have the structural integrity to survive manufacturing, packaging, distribution, and handling (e.g. non-sticky, non-breaking). Additionally, certain performance characteristics are required in order for the emulsions to be industrially viable such as proper demolding from standard confectionery molds (e.g. polycarbonate), proper release from belts and proper setting during panning applications. The emulsion coatings of the present invention have these properties.

There are several differences between the emulsion coatings of the present invention and traditional fat-based compositions. For example, the traditional fruit composition coating is composed of dried fruit solids (e.g. freeze dried raspberry powder), sugar and milk solids dispersed in a continuous fat or oil phase. The texture of the traditional coatings may be modified by a number of techniques known to those familiar in the art. These modifications may include changing the percentage of and type of fat in the composition, as well as changing the solid particle size, types of non-fat solids, and the ratio of non-fat solids to fat.

The emulsions and emulsion coatings of the present invention differ, in part, from conventional fat-based compositions in that they may generally be described as “water in oil” type emulsions. Although the majority of the emulsions may fit the “water in oil” model, portions of the emulsions may also contain “oil in water” sections or be separated into discrete phases. Additionally, in situations where fat is contained in the water phase, the emulsions are best described as oil in water in oil emulsions.

In an embodiment, a discontinuous or water phase of the emulsions may be composed of water with any added suitable additives (e.g. water-soluble), solids or dispersible materials. The additives, solids or dispersible materials can be, for example, surrounded by one or more emulsifiers. Small amounts of fat or oil may be emulsified into the aqueous phase thus resulting in oil in water in oil emulsion. Droplets of the discontinuous or water phase are dispersed within a fat continuous phase. It should be appreciated that the term droplet does not necessary refer to discrete spheres. In some high internal phase embodiments of this invention, aqueous zones are likely distorted from the ideal sphere but are still distinctly dispersed from the fat continuous phase.

Embodiments of the emulsion coatings of the present invention have the advantage in that they do not require non-fat solid particles dispersed in the continuous or fat phase. This results in a smooth coating that does not need to be refined or conched. Adding non-fat solids to the continuous phase completely changes the eating characteristics of the final water containing mass. Many of the previous emulsion-type masses described in the literature that specify coating applications also have dispersed non-fat solids in the continuous phase (W/O+S). There are a number of different methods of adding non-fat solids to the continuous phase. However in all instances the particle sizes of the dispersed solids must be reduced. In many instances the particles are added via chocolate or other confectionery masses that have been conched and refined.

In an embodiment, the emulsions generally comprise an aqueous or water phase and an oil or fat phase. The fat phase includes one or more emulsifiers and one or more tempering fats. In another embodiment, the fat phase is low in partially hydrogenated fats, low in lauric fats and free of waxes. Low in partially hydrogenated fats refers to, for example, having less than about 3% by weight of trans fats. Low in lauric fats refers to, for example, having less than about 10% by weight of lauric fats (e.g. palm kernel oil, coconut oil or their fractions). For example, the fat blend may contain lauric fats in amounts that do not soften the blend to the point where the blend cannot feasibly be used as a coating fat.

The primary type of fat(s) or oil(s) used in the emulsions should not be what is traditionally called partially hydrogenated fats or lauric fats. Lauric fats contain a large percentage of lauric acid in its triglyceride composition. In the presence of water, this lauric acid may be released and result in a soapy off flavor. Thus, the emulsions of the present invention should use low amounts.

In cases where the fat used in the emulsion is tempering, processing and/or formulation may be manipulated to achieve a desired crystal structure. The type of crystal form and packing will affect the processability and final product texture.

The tempering fat can be cocoa butter, cocoa butter equivalents, cocoa butter improvers and combinations thereof. Cocoa butter equivalents are made from, for example, palm oil, sunflower oil, safflower oil, sheanut butter, illipe butter and similar oils, which can be modified and blended in ways to mimic cocoa butter characteristics. Cocoa butter equivalents may be fractionated, partially to fully hydrogenated or inter-esterified. Typical commercial examples are the Palmy types from Fuji Vegetable Oils Co., Inc., and Choclin or Coberine from Loders-Croklaan. Cocoa butter improvers, which can be produced from the aforementioned oils are made from the hardest fractions of oils and are used to raise the melting point of the total fat portion of the emulsions and improve its crystallization behavior. An example of Cocoa butter improvers would be Akoimp from Aarhus Oils, Inc.

The emulsions can further comprise one or more suitable one seeding agents. The seeding agents can be any suitable seeding agents such as, for example, BOB (Bohenic-Oleic-Bohenic triglyceride) from Fuji Vegetable Oils Co., Inc., tempered cocoa butter, tempered cocoa butter equivalents or powdered (e.g. spray dried) cocoa butter in Beta Form VI from Barry-Callebaut.

Many of the emulsion-type masses previously described in the literature are not shelf-stable and allow microbial growth at room temperature because of high water content. Emulsion coatings of the present invention are shelf-stable and are created by lowering the water activity of the aqueous phase. In order to accomplish this, the tendency for the emulsion to become less stable as the viscosity of the aqueous phase increases had to be overcome. Additionally, it had to be assured that the aqueous phase did not crystallize out within the emulsion during storage.

The solids level of the water phase of the emulsions can be varied so that the emulsions have a water activity ranging from about 0.3 to about 0.84. Preferably, the water activity ranges from about 0.3 to about 0.80. For the water activity range between 0.3 and 0.60, the aqueous phase will be resistant to microbial growth thereby resulting in shelf-stable emulsions and confectionery products using such emulsions. For water activity ranging between 0.61-0.84, the aqueous phase may need to contain a preservative (i.e. sorbates) to prevent microbial growth or the emulsion coating will need to be processed and packaged such that the potential for microbial growth is limited (i.e. thermal processing/aseptic packaging).

The aqueous or water phase can be any desired flavor or color. For example, fruit solids can be included in the water phase to make a fruit flavored emulsion. The flavor and color of the emulsion may be modified by changing the composition of the dissolved or dispersed additives or solids (e.g. milk solids, fruits, sugars).

The water phase can comprise any suitable additives such as, for example, natural or artificial fruit juices and fruit juice concentrates, natural and artificial vegetable juices and vegetable juice concentrates, preservatives, carbohydrates, gums, proteins, sugars, polyols, minerals, starches, flavoring agents, salts, acidulants, emulsiflers, high HLB emulsifiers, cocoa powders, coloring agents and combinations thereof.

The water phase can also comprises additives such as, for example, cocoa derived solids, dairy derived solids, nut derived solids, fruit derived solids, vegetable derived solids, soy derived solids and combinations thereof.

Hydrocolloids may also be added to the aqueous phase. This will change the texture and performance characteristics of the resulting emulsion. It should be appreciated that any suitable types of hydrocolloid can be used.

The emulsifiers can be any suitable food grade emulsifiers such as, for example, monoglycerides, diglycerides, polyglycerol polyricinoleate, succinylated monoglyceride, polysorbate 65, acetylated monoglycerides, citric acid ester of monoglycerides, lactic acid esters of monoglycerides, diacetyl-tartaric acid ester of mono/diglycerides, glycerol lactopalmitate, sodium stearoyl-2-lactylate, lecithin, polysorbate 80, sucrose hexaeucerate, sugar esters and combinations thereof.

The sugar esters can be, for example, sucrose monostearate, sucrose monopalmitate, sucrose distearate, sucrose dipalmitate, sucrose alkylate and combinations thereof.

In an embodiment, the emulsions are used as an emulsion coating for confectionery products. In another embodiment, the emulsions are capable of forming a confectionery product that is molded or co-molded. For example, the emulsions may be utilized with any suitable confectionery molding, enrobing or panning applications. The emulsions also may be used either alone or in combination with traditional confectionery masses to product confectionery products.

### EXAMPLES

By way of example and not limitation, the following examples are illustrative of various embodiments of the present invention and further illustrate experimental testing conducted in accordance with embodiments of the present invention.

### EXAMPLE 1

### Processing Steps

In an embodiment, the emulsions are a water-in-oil emulsion comprising a water (e.g. syrup) phase and a fat or oil phase comprised of a blend of fats and emulsifiers. These two components (i.e. water phase and fat blend) are processed separately and blended together at a defined ratio to form the emulsions or emulsion coatings. Once formed, the emulsions undergo a final conditioning step before they are ready for use, for example, as a coating.

In an embodiment, the water phase is made by adding water, sugar and any other desired additives or ingredients to a mixer. The mixer can be traced (e.g. steam or water), have an agitation capability (e.g. swept-surface, planetary or regular) and be an open-air or a vacuum vessel. The water is heated to a temperature ranging between about 210 and 240° F. to melt and dissolve the sugars and other ingredients. The resulting syrup is cooled to less than 200° F. Glycerol is added to the syrup when the temperature is less than 158° F. The solids concentration and water activity of the final syrup are tested. Preferably, the solids concentration should range from about 70% to about 91% and the water activity should range from about 0.3 to about 0.84. The syrup is stored at room temperature until used in the next step where it is re-heated to about 110° F. to about 140° F. prior to the emulsion formation.

In an embodiment, the fat or oil phase is made by weighing ingredients for the fat blend (e.g. non-lauric fat and emulsifier mix) to determine the proper proportions. Depending on the batch size, all components can be weighed together. If the batch size is too large and the ingredients weight separately, the emulsifiers should be kept together. The fat blend is heated above the melting point of the emulsifiers. Typically, the temperature may range from about 160° F. to about 180° F.

The final emulsions are made from the prepared water phase (i.e. syrup) and fat phase. The heated fat blend is added to the mixing vessel for forming of the emulsions. The mixing vessel is steam or water-traced for heating and cooling and agitated (e.g. variable speed preferable). The water phase (i.e. syrup) is heated ranging from about 110° F. to about 140° F. prior to metering into the fat phase. The agitation rate is regulated to ensure a homogeneous mix. The final emulsion is then cooled. The water trace temperature is adjusted to ensure the required cooling profile (e.g. final emulsion composition should reach 90±10° F. prior to discharge).

In an embodiment, the emulsions are seeded. For example, the selected seeding agent is pre-crystallized. The seeding agent can be any suitable non-lauric fats such as tempered cocoa butters, tempered cocoa butter equivalents (“CBE”) or crystallization enhancers. Preferably, the seeding agent used is tempered/seeded to the required crystal structure and content. The crystallized seeding agent is added to the emulsion by preconditioning the emulsion to a temperature in the range of about 85° F. to about 95° F. The seeding agent is then blended into the conditioned emulsion. The seeded emulsion is ready for further manufacture or processing.

The mixing process leads to the formation of the emulsions. Specified ingredient selections and emulsifiers used to produce the stable emulsions are listed in the following examples.

### EXAMPLE 2

### Sample Emulsion Recipe

Water Phase

| | |
|---|---|
| Crystalline Fructose | 40-75% |
| Anhydrous Glucose | 0-27% |
| Raspberry Juice Concentrate, 65 Brix | 1-30% |
| Water | 10-20% |
| Granulated Sucrose | 1-10% |
| Glycerine | 1-10% |
| Sodium Chloride | 0-2% |
| Subtotal: | 100% |

Fat Phase

| | |
|---|---|
| CBE (Palmy MM7E) | 85-95% |
| Emulsifier 1 | 0-6% |
| Emulsifier 2 | 0-6% |
| Lecithin | 0-2% |
| Subtotal: | 100% |

Complete Emulsion

| | |
|---|---|
| Water Phase | 50-80% |
| Fat Phase | 20-50% |
| Tempering Agent | 0-5% |
| Subtotal: | 100% |

### EXAMPLE 3

### Sample Emulsion Recipe

Water Phase

| | |
|---|---|
| Fructose | 50-75% |
| Dextrose | 0-27% |
| Milk Fat | 0-10% |
| Water | 10-20% |
| Glycerine | 0-18% |
| Salt | 0-7% |
| Milk Protein | 0-5% |
| Hydrocolloids | 0-2.5% |

Fat Phase

| | |
|---|---|
| Tempering Fat | 85-95% |
| Emulsifier 1 | 0-6% |
| Emulsifier 2 | 0-6% |
| Lecithin | 0-2% |

Emulsion

| | |
|---|---|
| Fat Phase | 20-50% |
| Water Phase | 50-80% |
| Fat | 0-5% |

### EXAMPLE 4

### Sample Emulsion Recipe

Water Phase

| | |
|---|---|
| Fructose | 50-75% |
| Dextrose | 0-27% |
| Whole Milk | 0-27% |
| Sorbitol | 0-5% |
| Water | 10-20% |
| Glycerine | 0-18% |
| Salt | 0-7% |
| Flavor | 0-2% |

Fat Phase

| | |
|---|---|
| Tempering Fat | 85-95% |
| Emulsifier 1 | 0-6% |
| Emulsifier 2 | 0-6% |
| Emulsifier 3 | 0-2% |

Emulsion

| | |
|---|---|
| Fat Phase | 10-50 |
| Water Phase | 50-90 |
| Fat | 0-1 |

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. An emulsion comprising:
a water phase and
a fat phase having at least one emulsifier and at least one tempering fat.

2. The emulsion of claim 1, wherein the fat phase is low in partially hydrogenated fats.

3. The emulsion of claim 1, wherein the fat phase is low in lauric fats.

4. The emulsion of claim 1, wherein the fat phase is free of waxes.

5. The emulsion of claim 1, wherein the tempering fat is selected from the group consisting of cocoa butter, cocoa butter equivalents, cocoa butter improvers and combinations thereof.

6. The emulsion of claim 5, wherein the cocoa butter equivalents are made from components selected from the group consisting of palm oil, sunflower oil, safflower oil, sheanut butter, illipe butter and combinations thereof.

7. The emulsion of claim 1, wherein the emulsifier is selected from the group consisting of monoglycerides, diglycerides, polyglycerol polyricinoleate, succinylated monoglyceride, polysorbate 65, acetylated monoglycerides, citric acid ester of monoglycerides, lactic acid esters of monoglycerides, diacetyl-tartaric acid ester of mono/diglycerides, glycerol lactopalmitate, sodium stearoyl-2-lactylate, lecithin, polysorbate 80, sucrose hexaeucerate, sugar esters and combinations thereof.

8. The emulsion of claim 7, wherein the sugar esters are selected from the group consisting of sucrose monostearate, sucrose monopalmitate, sucrose distearate, sucrose dipalmitate, sucrose alkylate and combinations thereof.

9. The emulsion of claim 1 further comprising at least one seeding agent.

10. The emulsion of claim 9, wherein the seeding agent is selected from the group consisting of bohenic-oleic-bohenic triglyceride, tempered cocoa butters, tempered cocoa butter equivalents, crystallization enhancers, powdered cocoa butter and combinations thereof.

11. The emulsion of claim 1, wherein the water phase comprises additives selected from the group consisting of fruit juices, fruit juice concentrates, vegetable juices, vegetable juice concentrates, preservatives, carbohydrates, gums, proteins, sugars, polyols, minerals, hydrocolloids, starches, flavoring agents, salts, acidulants, emulsifiers, high HLB emulsifiers, cocoa powders, coloring agents and combinations thereof.

12. The emulsion of claim 1, wherein the water phase comprises additives selected from the group consisting of cocoa derived solids, dairy derived solids, nut derived solids, fruit derived solids, vegetable derived solids, soy derived solids and combinations thereof.

13. The emulsion of claim 1, wherein the emulsion has a water activity ranging from about 0.3 to about 0.84.

14. The emulsion of claim 1, wherein the emulsion is used as a coating for confectionery products.

15. The emulsion of claim 1, wherein the emulsion is capable of forming a coating for a confectionery product by an application selected from the group consisting of molding, co-molding, enrobing, spray coating, pan coating and combinations thereof.

16. The emulsion of claim 1, wherein the emulsion is shelf-stable.

17. An emulsion for confectionery applications comprising:
a water phase and
a fat phase having at least one emulsifier, wherein the fat phase is low in partially hydrogenated fats and lauric fats and wherein the fat phase is free of waxes.

18. The emulsion of claim 17 further comprising at least one seeding agent.

19. A confectionery product comprising an emulsion having
a water phase and
a fat phase having at least one emulsifier and at least one tempering fat, wherein the fat phase is low in partially hydrogenated fats and lauric fats and free of waxes.

20. A method of making an emulsion, the method comprising:
preparing a water phase by mixing and heating a combination of water and additives to form a syrup,
preparing a fat phase by blending and heating at least one tempering fat and at least one emulsifier to form a fat blend,
combining the syrup with the fat blend, and
adding at least one seeding agent to the combined syrup and fat blend to form the emulsion.

21. A method of making an emulsion for confectionery coating applications, the method comprising:
preparing a water phase by mixing and heating a combination of water and additives to form a syrup,
preparing a fat phase by blending and heating at least one fat and at least one emulsifier to form a fat blend, wherein the fat phase is low in partially hydrogenated fats and lauric fats and free of waxes,
combining the syrup with the fat blend, and
adding at least one seeding agent to the combined syrup and fat blend to form the emulsion, wherein the emulsion does not need to be refined or conched.
